(19) United States
(12) Patent Application Publication
(10) Pub. No.: US 2005/0032508 A1
(43) Pub. Date: Feb. 10, 2005

(54) Method for producing a watcher list

(76) Inventors: Andreas Hauptvogel, Berlin (DE); Michael Lemke, Berlin (DE)

Correspondence Address: MORRISON & FOERSTER LLP, 1650 TYSONS BOULEVARD, SUITE 300, MCLEAN, VA, 22102, US

(21) Appl. No.: 10/651,249

(22) Filed: Aug. 29, 2003

(30) Foreign Application Priority Data
Sep. 2, 2002 (DE) 102 41 094.1

(51) Int. Cl. H04M 3/42

(52) U.S. Cl. 455/415

(57) ABSTRACT

A method for producing a watcher list by a mobile telephone, with the watcher list including identifiers for people or communication devices whose status is intended to be watched by a presence computer PR which is connected to a mobile radio network, and whose status information is configured to be displayed on a display unit, on the mobile telephone. In this case, identifiers, which are already stored as telephone book data in a telephone book store and are associated with people or communication devices are read from the telephone book store in the mobile telephone, and in response to a control signal, a selection of these identifiers is marked as identifiers to be watched, and identifiers in the form of information relating to these identifiers to be watched, in order to form the watcher list.

### CLAIM FOR PRIORITY

This application claims priority to German application 10241094.1, which was filed in the German language on Sep. 2, 2002, the contents of which are hereby incorporated by reference.

### TECHNICAL FIELD OF THE INVENTION

The invention relates to a method for producing a watcher list via a mobile telephone.

### BACKGROUND OF THE INVENTION

A service which is known as a “presence service” is disclosed in document 3GPP TS 23.141 V0.0.0. “3rd Generation Partnership Project; Technical Specification Group Services and System Aspects; Presence Service; Architecture and Functional Description (Release 6)”, dated June 2002, in which a presence computer (presence server) is used to watch for characteristics of selected communication subscribers. These characteristics include, for example, the respective current accessibility by telephone, by written short messages (SMS) or by e-mail. In order to indicate the communication subscribers about whom a specific user wishes to receive information by means of such presence characteristics, the respective user sends a watcher list to the presence computer. This watcher list contains an enumeration of the people who are of interest to the user and are to be watched, and of their communication terminals.

### SUMMARY OF THE INVENTION

The invention specifies a method which produces a watcher list.

According to one embodiment of the invention, there is a method for producing a watcher list via a mobile telephone, with the watcher list including identifiers for people or communication devices whose status is configured to be watched by a presence computer which is connected to a mobile radio network, and whose status information is configured to be displayed on a display unit, on the mobile telephone, in which identifiers which are already stored as telephone book data in a telephone book store and are associated with people or communication devices are read from the telephone book store in the mobile telephone, in response to a control signal, a selection of these identifiers is marked as identifiers to be watched, and identifiers in the form of information relating to these identifiers to be watched, are collated in order to form the watcher list. One advantage of the method is that the telephone book data which is stored in the telephone store in the mobile telephone is used to produce the watcher list. Data which is kept in store in order to simplify the process of setting up a telephone connection in the mobile telephone is thus advantageously also used to produce the watcher list. Consequently, data such as this does not need to be recorded or entered once again by means of the mobile telephone, but can be reused in a convenient manner.

In one advantageous aspect of the method according to the invention, the watcher list is stored in a further store in the mobile telephone. The watcher list can thus be stored in the mobile telephone, such that it can be added to or revised later.

In one preferred embodiment of the method according to the invention, a SIM card which is connected to the mobile telephone or a preselected area of a RAM store in the mobile telephone can be used as the telephone book store.

The method according to the invention can preferably be carried out such that the identifiers are produced by means of a data transfer of parts of the identifiers to be watched, from the telephone book store. A data transfer such as this (copying process) can advantageously be carried out very quickly and easily; the storage space required for the watcher list is kept small by restricting the data transfer to those parts of the respective identifiers which are relevant for watching.

### BRIEF DESCRIPTION OF THE IVENTION

In order to explain the invention further,

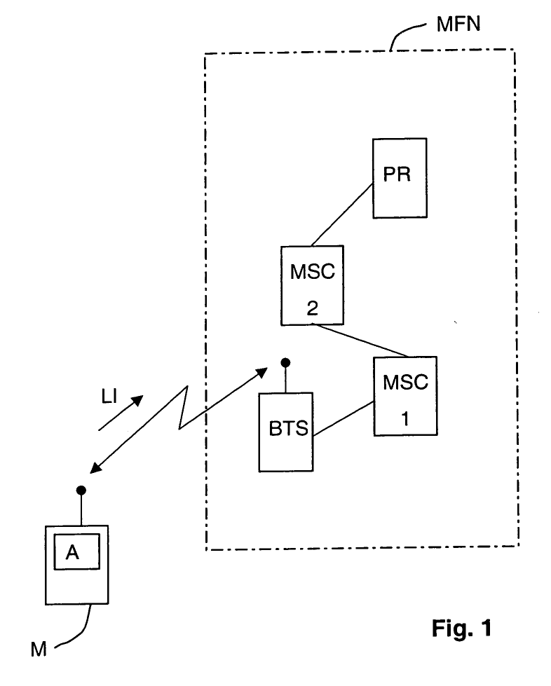

FIG. 1 shows an exemplary embodiment of a mobile radio network which is connected to a mobile telephone.

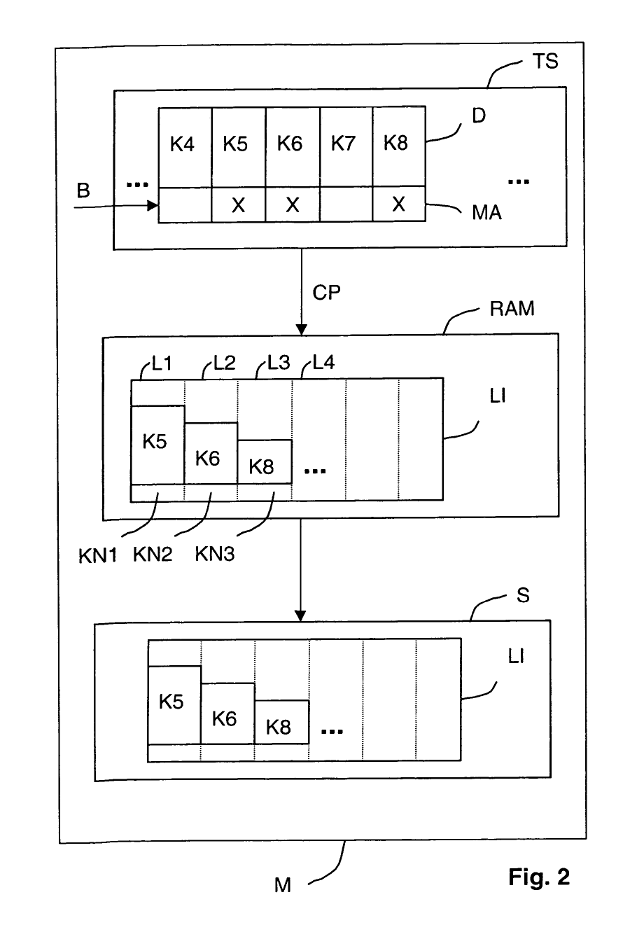

FIG. 2 shows a detailed exemplary embodiment of the method according to the invention.

### DETAILED DESCRIPTION OF THE INVENTION

FIG. 1 shows a mobile telephone M with a display unit A, and which is connected to a mobile radio network MFN via an air interface. The air interface connects the mobile telephone M to a base station BTS (BTS=Base Transceiver Station), which is connected via a first mobile switching center MSC1 (MSC=Mobile Services Switching Center) and a second mobile switching center MSC2 to a presence computer PR (PR=Presence Server). In this case, the presence computer PR may also be located in another mobile radio network (not shown in FIG. 1), provided that this further mobile radio network is connected to the mobile radio network MFN that is illustrated in FIG. 1. The mobile telephone M produces a watcher list LI and transmits it to the presence computer PR via the air interface, the base station BTS and the mobile switching centers MSC1 and MSC2.

FIG. 2 shows the steps which are carried out within the mobile telephone M in order to produce the watcher list LI. Identifiers K4, K5, K6, K7 and K8 for people or for communication terminals are stored in a telephone book store TS in the mobile telephone M. Telephone book stores TS such as these in mobile telephones are also occasionally referred to as address book stores. This is the case in particular when they are used to store further details such as addresses or personal notes as well, in addition to the name and the telephone number of the communication subscriber.

The identifier K5 in the telephone book store TS includes, for example, the name, the address and the mobile telephone number of a first mobile telephone user, to whom mobile telephone connections have already been made two or more times in the past from the mobile telephone M. For this reason, this identifier K4 is stored as a component of the telephone book data D in the telephone book store TS in the mobile telephone M. In an analogous manner, the identifiers K4, K6, K7 and K8 include data and information relating to four other potential communication partners, to whom communication connections can be set up from the mobile telephone M. The identifiers K4, K5, K6, K7 and K8 thus form some of the telephone book data D which is stored in the telephone book store TS.

A telephone book store TS such as this may, for example, be represented by a SIM card (SIM=Subscriber Identity Module) in the mobile telephone M. However, a preselected area of the main memory RAM (RAM=Random Access Memory) in the mobile telephone can also be used as the telephone book store. This is particularly advantageous when a relatively large amount of telephone book data is stored in the telephone book store, so that the storage capacity of a SIM card is exceeded.

In the present exemplary embodiment, the people or communication devices (for example mobile telephones, landline telephones, laptops, palmtops or computers with Internet browsers) associated with the identifiers K5, K6 and K8 are now intended to be watched. For this purpose, the identifiers K4, K5, K6, K7 and K8 are read from the telephone book store TS and, for example, are displayed on the display unit A (see FIG. 1) on the mobile telephone. In response to an appropriate control signal B (for example a keypad input on the mobile telephone M), the identifiers K5, K6 and K8 which are selected in this example are provided with a marking MA. This can be done, for example, by setting a flag X, which is associated with the respective identifier, in the telephone book store TS (that is to say a storage location with a predetermined value). Data is then transferred CP (a copying process “Copy”) from the telephone store TS to a main memory RAM in the mobile telephone. During this data transfer, at least parts of the marked identifiers are transferred to the main memory RAM. In the present exemplary embodiment, the identifier K5 is transferred completely and forms a data record (annotated by a first identifier KN1) in the main memory RAM. However, a portion of the information from the identifier K6 in the telephone book store TS is copied to the main memory RAM.

This portion of the information (symbolized by a small rectangle K6) forms a second identifier KN2 in the main memory RAM. Finally, an even smaller proportion of the data for the identifier K8 is copied from the telephone book store TS to the main store, thus forming a third identifier KN3. The first identifier KN1 represents a first list element L1 in the watcher list LI, the second identifier KN2 forms a second list element L2, and the third identifier K3 forms a third list element L3. The list elements L1, L2, L3 and, possibly, further list elements L4 etc. are, finally, collated to form the watcher list LI.

Finally, the complete watcher list LI is buffer-stored in a further store S (for example in a short-term memory) in the mobile telephone M and, in a later step, is transferred from the mobile telephone M to the presence computer PR.

In the method according to the invention, data which is associated with potential communication partners and is stored in the telephone book TS in the mobile M is used to produce a watcher list, which has to be produced for a presence service. There is therefore advantageously no need to enter this data in the mobile communication terminal in order to produce the list. This, on the one hand, results in a list production method which is very simple, by means of which, in particular, a list can be produced in a short time. On the other hand—particularly when lists have been produced repeatedly—it avoids the necessity to repeatedly enter data by means of input devices (for example keys) on the mobile telephone, thus lengthening the life of the input devices.

1. A method for producing a watcher list via a mobile telephone, the watcher list including identifiers for people or communication devices having a status configured to be watched by a presence computer connected to a mobile radio network, and the status information is configured to be displayed on a display unit on the mobile telephone, comprising:
reading identifiers which are stored as telephone book data in a telephone book store and are associated with people or communication devices from the telephone book store in the mobile telephone;
marking, in response to a control signal, a selection of the identifiers as identifiers to be watched; and
collating identifiers in the form of information relating to the identifiers to be watched to form the watcher list.

2. The method as claimed in claim 1, wherein the watcher list is stored in a store in the mobile telephone.

3. The method as claimed in claim 1, a SIM card which is connected to the mobile telephone is used as the telephone book store.

4. The method as claimed in claim 1, wherein a preselected area of a RAM store in the mobile telephone is used as the telephone book store.

5. The method as claimed in claim 1, wherein the identifiers are produced by a data transfer of parts of the identifiers to be watched, from the telephone book store.
